(19) United States
(12) Patent Application Publication
(10) Pub. No.: US 2010/0275826 A1
(43) Pub. Date: Nov. 4, 2010

(54) Method for Increasing Organic Carbon Content of Soil Employing Industrial Wastewater and Green Manure Crops

(76) Inventors: Chiu-Chung YOUNG, Dali City (TW); Chin-Ching Lin, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/181,933

(22) Filed: Jul. 29, 2008

(51) Int. Cl. A01C 21/00

(52) U.S. Cl. 111/118

(57) ABSTRACT

A method for increasing the organic carbon content of soil employing industrial wastewater and green manure crops comprises adding industrial wastewater containing cyclic phenolic substances or nitrogen compounds or a mixture of the above two kinds of industrial wastewater into the soil with the application of green manure crops to increase the organic carbon content of the soil and facilitate the humification thereby stabilizing the organic carbon in the soil.

### BACKGROUND OF THE INVENTION

(a) Field of the Invention

The present invention relates to soil and environmental conservation, and more particularly to a method for increasing the organic carbon content of soil employing industrial wastewater and green manure crops.

(b) Description of the Prior Art

Soil is the property on which people live for generations, and it is the foundation of life such as providing a medium for crop growth. Therefore, the topic of soil and environmental conservation has attracted a lot of interests in the world. However, the crucial problem of soil and environmental conservation is how to prevent soil deterioration. The soil fertility index is related to the organic matter in the soil, and the organic matter in the soil can be divided into easily decomposable, unstable nonhumic substances and hardly decomposable, stable humic substances. The humic substances are the essence and fertility index of the soil and hardly decomposed by microbes. The organic carbon content of the soil is the index of soil health and agricultural productivity. The structure of the humic substances is a complicated complex of multiple straight chain and aromatic cyclic organic compounds. It is the persistent organic matter of the soil and has high nutrient- and water-retaining capacities, which can enhance the buffer capacity of the soil and reduce the soil salinity. Besides, it can alleviate hazard of toxic substances to crops, and can improve and maintain the soil quality. Accordingly, sustainable agricultural yield must depend on the maintenance of the organic carbon content of the soil.

However, the organic carbon content of the soil is affected by implantation of organic substances into the soil (planting), output (mineralization), erosion and wash-off and drops gradually. Particularly, carbon is mineralized at a relatively rapid rate in the cultivation of paddy so a larger amount of organic substances must be added to maintain the soil fertility, wherein a green manure crop is a kind of organic matter that is frequently used to increase the organic carbon and nitrogen contents. The green manure crops are fresh plants planted in a farmland, which can be directly plowed into the soil and function as fertilizers. Therefore, the application of green manure crops as organic raw materials to the soil is the most widely used, economical and effective method. In terms of the subtropical countries, the conditions of high rainfall and high humidity accelerate the mineralization rate of green manure crops and cause rapid decomposition rate of green manure crops. Moreover, the early study pointed out that the application of a great amount of green manure crops provides poor effect of the increased organic matter in the soil, and only gains a minute quantity, even none of organic matter in the soil. Hence, the application of green manure crops (e.g. sesbania) to the soil can only increase the organic carbon content of the soil in a paddy field temporarily, but cannot provide organic carbon storage for a longer period of time.

Therefore, in view of the drawbacks of the realization of the method for increasing the organic carbon content of soil with direct application of green manure crops to a cultivated land of the prior art, the inventors propose a method for increasing the organic carbon content of soil employing industrial wastewater and green manure crops based on their intensive research and development for many years and plenty of practical experience.

### SUMMARY OF THE INVENTION

A primary objective of the present invention is to provide a method for increasing the organic carbon content of soil employing industrial wastewater and green manure crops, which utilizes industrial wastewater containing cyclic phenolic substances or nitrogen compounds with the application of green manure crops to increase the organic carbon content of the soil and facilitate the humification thereby stabilizing the organic carbon in the soil.

To achieve the foregoing objective, the present invention provides a method for increasing the organic carbon content of soil employing industrial wastewater and green manure crops, which comprises adding industrial wastewater containing cyclic phenolic substances or nitrogen compounds or a mixture of the above two kinds of industrial wastewater into the soil with the application of green manure crops to increase the organic carbon content of the soil and facilitate the humification thereby stabilizing the organic carbon in the soil.

### BRIEF DESCRIPTION OF THE DRAWINGS

FIG. 1 is a diagram showing changes in the organic carbon contents of the soil among different treatments during different incubation periods according to the present invention.

FIG. 2 is a diagram showing changes in the carbon contents of humic substances in the soil among different treatments during different incubation periods according to the present invention.

FIG. 3 is a diagram showing changes in the carbon contents of fulvic acid in the soil among different treatments during different incubation periods according to the present invention.

Table 1 is a table of relative changes in C_{HS}, C_{HA}, and C_{FA} ratios after incubation of 103 days among different treatments according to the present invention.

Table 2 is a table of relative changes in the carbon contents of different fractions of alkali-soluble organic carbon during the incubation period according to the present invention.

Table 3 is a table of relative changes in C_{HA}/C_{FA} ratios, humification index, and gain in TOC during the incubation period of 103 days in different treatments according to the present invention.

Table 4A is a Fourier transform infrared spectrum of humic acid in all the treated soil before incubation (on the 0th day) according to the present invention.

Table 4B is a Fourier transform infrared spectrum of humic acid in all the treated soil after incubation of 103 days according to the present invention.

Table 5A is a Fourier transform infrared spectrum of fulvic acid in all the treated soil before incubation (on the 0th day) according to the present invention.

Table 5B is a Fourier transform infrared spectrum of fulvic acid in all the treated soil after incubation of 103 days according to the present invention.

### DETAILED DESCRIPTION OF THE PREFERRED EMBODIMENTS

The present invention provides a method for increasing the organic carbon content of soil employing industrial wastewater and green manure crops, which comprises adding industrial wastewater containing cyclic phenolic substances or nitrogen compounds into the soil with the application of green manure crops to increase the organic carbon content of the soil, wherein:

The soil used in the present invention is collected from the soil of Chencuoliao, Minxiong Shiang, Chiayi County, Taiwan (R.O.C.), in which the soil texture is silty clay with a pH value of 6.5, the conductance of 0.87 dS m⁻¹, the content of organic matters of 1.07%, the extracted phosphorus content (Bray-1) of 32.1 mg kg⁻¹, the potassium content of 160 mg kg⁻¹, the calcium content of 755 mg kg⁻¹, the magnesium content of 253 mg kg⁻¹, the iron content of 175 mg kg⁻¹, the manganese content of 120 mg kg⁻¹, the copper content of 2.9 mg kg⁻¹, the zinc content of 4.4 mg kg⁻¹. After air-dried and sieved (2×2 mm mesh size), the soil is subjected to the subsequent test.

The green manure crop of the present invention may include sesbania (Sesbania roxburghii Merr.), sun hemp (Crotaleria juncea L.), soybeans (Glycine max L.), rape (Brassica campestris L.), Chinese milk vetch (Astragalus sinicus), Egyptian clover (Trifolium alexandrinum L.), vetch (Vicia spp.), radish, buch wheat (Fagopyrum esculentum), Pale-flowered knotweed (Polygonum lapathifolum L.), gum bearer, velvet bean (Mucuna capitate) yokohama bean (Stizolobium hassjoo), lupine (Lupines micrenthus Guss.) or peanut (Arachis hypogaea L.). In this example, after air-dried, snipped, and sieved (4×4 mm mesh size), the thalli of sesbania (Sesbania roxburghii Merr.) are used as the green manure crop of the present invention.

Moreover, the industrial wastewater containing nitrogen compounds according to the present invention is collected from amino acid-containing wastewater (WS) discharged from a food processing plant of Taiwan Vedan Enterprise Corporation, and the industrial wastewater containing cyclic phenolic substances according to the present invention is collected from lignocellulose-containing wastewater (WP) discharged from a paper mill of Taiwan Pulp and Paper Corporation.

The treatment of the present invention is divided into one with the application of 0.1% to 10% of sesbania based on the weight of the soil and the other without the application of sesbania. In this example, 300 g of air-dried soil is placed in a 500 ml Erlenmeyer flask, and the flasks each containing the soil with the application of 3 g of sesbania (1% based on the weight of the soil) and the soil without the application of sesbania are flooded with deionized water up to 2 mm above the soil surface (similar to a paddy field environment). The Erlenmeyer flasks are capped with aluminum foil and then kept in the environment of 25° C. with humidity of 30%^{˜}100% (in this example, the environment of humidity of 95% as the test condition) for incubation. The aluminum foil is opened for one hour every day to avoid an anaerobic condition within the flask, and distilled water is added to the soil to maintain the water level. After incubation of 15 days, the wastewater is added to perform the test. The test is divided into separate test groups respectively with no addition of the wastewater; with the addition of the food plant wastewater to the soil at the ratio of 0.0016^{˜}1 (ml/g), in this example, with the addition of 4 ml of the food plant wastewater (Soil+WS); with the addition of the paper mill wastewater to the soil at the ratio of 0.0016^{˜}1 (ml/g), in this example, with the addition of 2 ml of the paper mill wastewater (Soil+WP); with the addition of the food plant wastewater and the paper mill wastewater (Soil+WS+WP), wherein the food plant wastewater and the paper mill wastewater are formulated and mixed at the ratio of 2:1 (4 ml:2 ml), and after mixing, the ratio of the wastewater to the soil is as same as 0.0016^{˜}1.

Samples are obtained, and pH values, the organic carbon contents and alkali-soluble organic substances (humic substances) of the soil are analyzed respectively on the 0th day, 6th day, 12th day, 22nd day, 33rd day, 43rd day, 53rd day, 63rd day, 83rd day and 103rd day after treatment is initiated.

In analyzing the organic carbon contents of alkali-soluble organic substances, humic substances are extracted from 10 g of the sample with 100 ml 0.1M NaOH, followed by centrifugation for 5^{˜}30 minutes at 5000^{˜}15000 rpm to give the supernatant, i.e. the humic substances (HS). The humic substance solution is then adjusted to pH 2, and the precipitable humic acid (HA) and the supernatant fulvic acid (FA) are separated by a centrifugal method. The organic carbon content of the humic substances (C_{HS}) and the organic carbon content of the fulvic acid (C_{FA}) are analyzed using a TOC analyzer, and the organic carbon content of the humic acid (C_{HA}) is obtained by subtraction of the organic carbon content of the fulvic acid from the organic carbon content of the humic substances.

Wherein the extraction and purification procedures for humic acid and fulvic acid are conducted in accordance with the standard method of operation of the International Humic Substances Society (IHSS), and the contents of humic acid and fulvic acid are analyzed by Fourier transform infrared (FTIR) spectral analysis. A two-factor analysis of variance (ANOVA) was performed for statistical analysis of differences among treatments to discover if there is a significant difference (P<0.05) in variance.

### Test Example 1

### Relative Changes in the Total Organic Carbon Contents Of the Soil Among Different Treatments During the Incubation Period

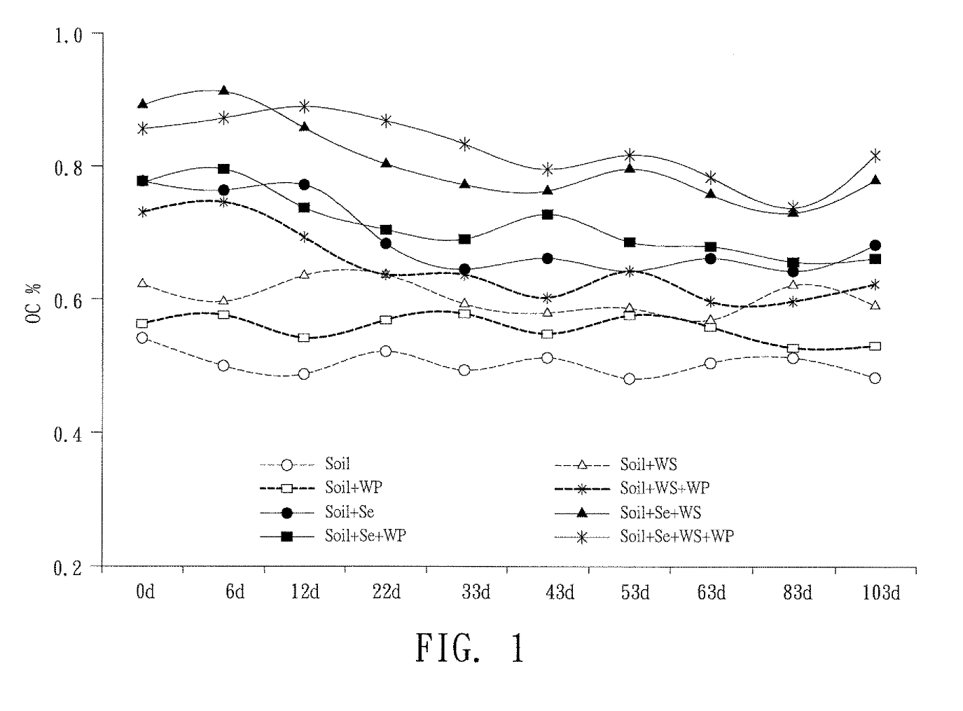

As illustrated in FIG. 1, the organic carbon contents of all the soil tend to drop off during the incubation period. The four treated soil with the application of sesbania include the soil with the application of sesbania (Soil+Se), the soil with the application of sesbania and with addition of the food plant wastewater (Soil+Se+WS), the soil with the application of sesbania and with addition of the paper mill wastewater (Soil+Se+WP), and the soil with the application of sesbania and with the addition of the food plant wastewater and the paper mill wastewater (Soil+Se+WS+WP). Compared with the soil without the application of sesbania, the total organic carbon content of the soil with the application of sesbania and with addition of the food plant wastewater (Soil+Se+WS) is highest, and the next highest is the organic carbon content of the soil with the application of sesbania and with the addition of the food plant wastewater and the paper mill wastewater (Soil+Se+WS+WP) of 0.86% when the incubation starts (on the 0th day). It can be found that the application of sesbania (Soil+Se) can increase the organic carbon content of the initial soil up to 44%, and the addition of the food plant wastewater and the paper mill wastewater (Soil+WS+WP) can also increase the organic carbon content of the initial soil up to 36% in comparison with the control soil (Soil). There is no significant difference between the organic carbon content of the control soil (Soil) and that of the soil with the addition of the paper mill wastewater (Soil+WP) at the very start, and there is no significant difference between the organic carbon content of the soil with the application of sesbania and with addition of the paper mill wastewater (Soil+Se+WP) and the soil with the application of sesbania (Soil+Se). It is shown that the addition of the paper mill wastewater (WP) does not increase the total organic carbon content of the initial soil, but the organic carbon content of the soil with addition of the food plant wastewater (Soil+WS) has risen 15%. The reason lies in that the food plant wastewater (WS) has higher organic carbon content.

After incubation of 103 days, the total organic carbon contents of the soil with the application of sesbania and with the addition of the food plant wastewater and the paper mill wastewater (Soil+Se+WS+WP), the soil with addition of the food plant wastewater (Soil+WS) and the soil with the addition of the paper mill wastewater (Soil+WP) only drop 5%, but the organic carbon content of the control soil (Soil) drops 9% compared with the initial organic carbon content. The reason is that there is very high carbon mineralization occurred in the test soil. The organic carbon content of the soil with the addition of the food plant wastewater and the paper mill wastewater (Soil+WS+WP) decreases 15%, and the organic carbon content of the soil with the application of sesbania and with the addition of the paper mill wastewater (Soil+Se+WP) decreases 14%, and the organic carbon content of the soil with the application of sesbania and with the addition of the food plant wastewater (Soil+Se+WS) decreases 13%. The organic carbon content of the soil with the application of sesbania (Soil+Se) within 15 days after flooded with water decreases 15%, and after incubation of 103 days decreases 13%. However, the organic carbon content of the soil with the application of sesbania or with the addition of the industrial wastewater after incubation of 103 days is still higher than that of the control soil (Soil). It is obvious from the result of this study that the carbon mineralization rate of the soil with the application of sesbania and with the addition of the food plant wastewater and the paper mill wastewater (Soil+Se+WS+WP) is lowest, and the organic carbon content of said soil rises 167% compared with the control soil (Soil). In the cultivation of paddy, the use of such treatments allows the organic carbon content of the soil to be effectively increased and maintained stably. Moreover, higher organic carbon content can enhance the cation exchange ability of soil in order to maintain the soil fertility.

### Test Example 2

### Relative Changes in the Carbon Content of the Humic Substances (C_{HS}), the Carbon Content of the Humic Acid (C_{HA}), and the Carbon Content of the Fulvic Acid (C_{FA}) of the Soil Among Different Treatments During the Incubation Period

The relatively stable organic carbon in the soil mainly exists in humic substances so the changes in the carbon content of the humic substances (C_{HS}) reflect the stability of organic carbon in the soil.

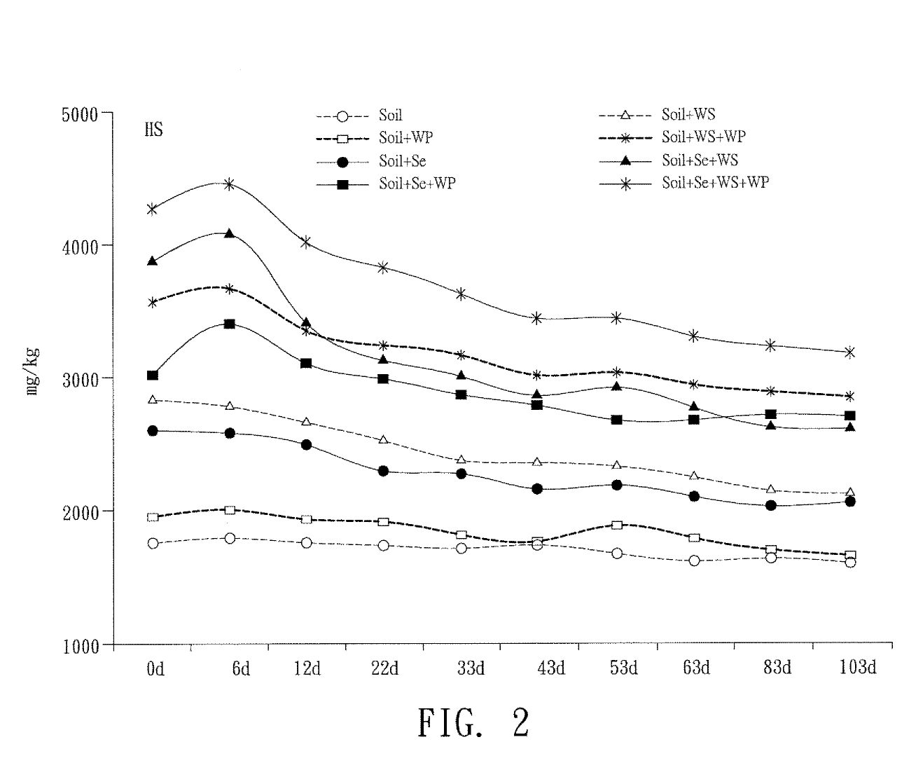

Referring to FIG. 2, it is shown from the result of this study that the soil with the application of sesbania and with the addition of the food plant wastewater and the paper mill wastewater (Soil+Se+WS+WP) has the highest carbon content of the humic substances (C_{HS}) when the incubation starts (on the 0th day), and increases 243% compared with the control soil (Soil). The carbon content of the humic substances (C_{HS}) of the soil with the application of sesbania and with the addition of the food plant wastewater (Soil+Se+WS) rises 120%, and the carbon content of the humic substances (C_{HS}) of the soil with the addition of the food plant wastewater and the paper mill wastewater (Soil+WS+WP) rises 130%, and the soil with the application of sesbania (Soil+Se) can increase the carbon content of the humic substances (C_{HS}) up to 48%. After incubation of 103 days, the carbon content of the humic substances (C_{HS}) of the soil with the application of sesbania and with the addition of the food plant wastewater (Soil+Se+WS) decreases 25%, and the carbon content of the humic substances (C_{HS}) of the soil with the application of sesbania and with the addition of the food plant wastewater and the paper mill wastewater (Soil+Se+WS+WP) decreases 25%, and the carbon content of the humic substances (C_{HS}) of the soil with the application of sesbania (Soil+Se) decreases 21%. There is a decrease in the carbon content of the humic substances (C_{HS}) in each of the above treatments after incubation of 103 days, but as listed in Table 1, all the above cases still have higher carbon contents of the humic substances (C_{HS}) compared with the control soil (Soil).

In studying relative changes in the carbon contents of different fractions of alkali-soluble organic carbon during the incubation period, when the incubation starts (on the 0th day), 32% of the total organic carbon in the control soil (Soil) comes from the carbon of the humic substances in the soil, and 50% of the total organic carbon in the soil with the application of sesbania and with the addition of the paper mill wastewater (Soil+Se+WP) comes from the carbon of the humic substances in the soil, and 50% of the total organic carbon in the soil with the application of sesbania and with the addition of the food plant wastewater and the paper mill wastewater (Soil+Se+WS+WP) comes from the carbon of the humic substances in the soil. As listed in Table 2, after incubation of 103 days, 33% of the total organic carbon in the control soil (Soil) comes from the carbon of the humic substances in the soil, and 41% of the total organic carbon in the soil with the application of sesbania and with the addition of the paper mill wastewater (Soil+Se+WP) comes from the carbon of the humic substances in the soil, and 39% of the total organic carbon in the soil with the application of sesbania and with the addition of the food plant wastewater and the paper mill wastewater (Soil+Se+WS+WP) comes from the carbon of the humic substances in the soil. The ratio of the carbon of the humic substances in the soil with the addition of the food plant wastewater and the paper mill wastewater (Soil+WS+WP) to the total organic carbon content (C_{HS}/TOC) rises from 41% to 46% but tends to drop off among the other treatments.

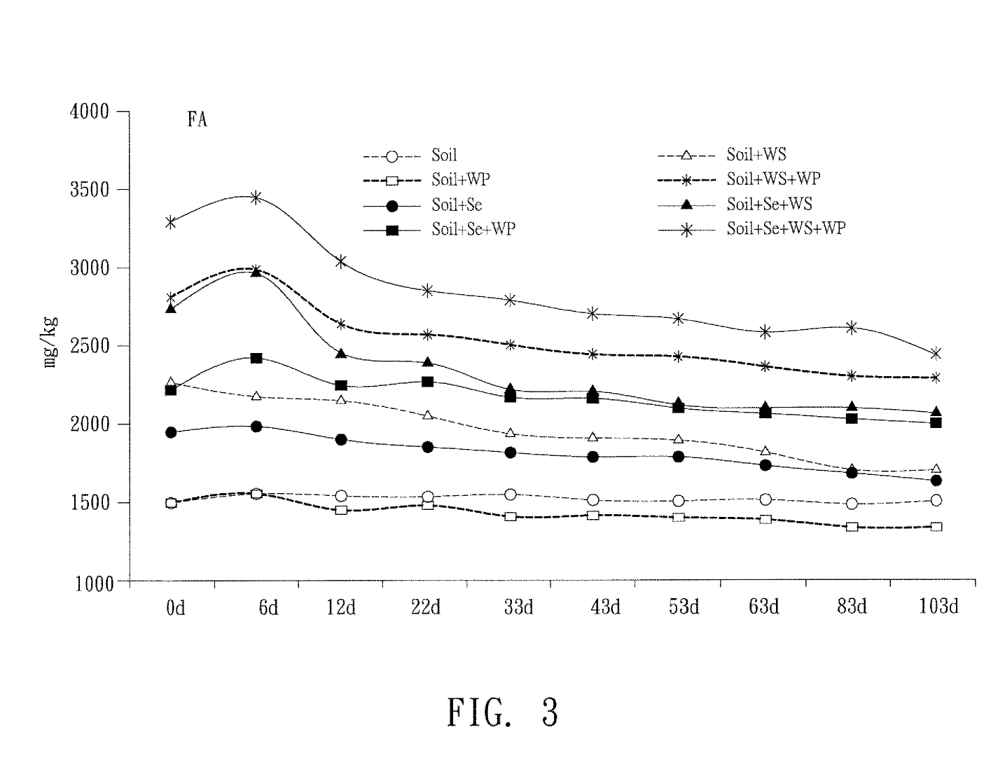

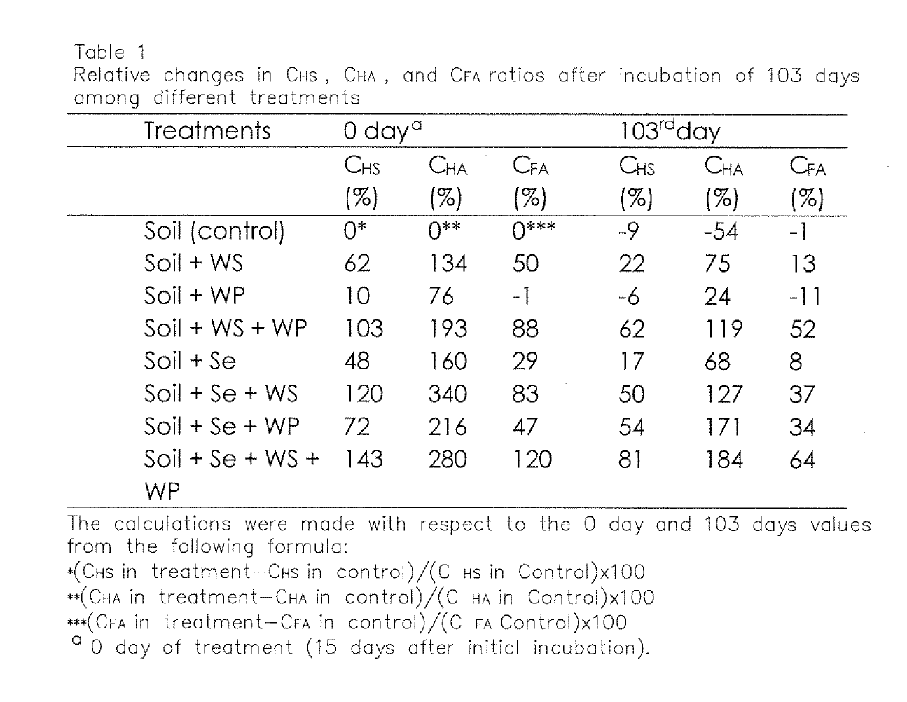

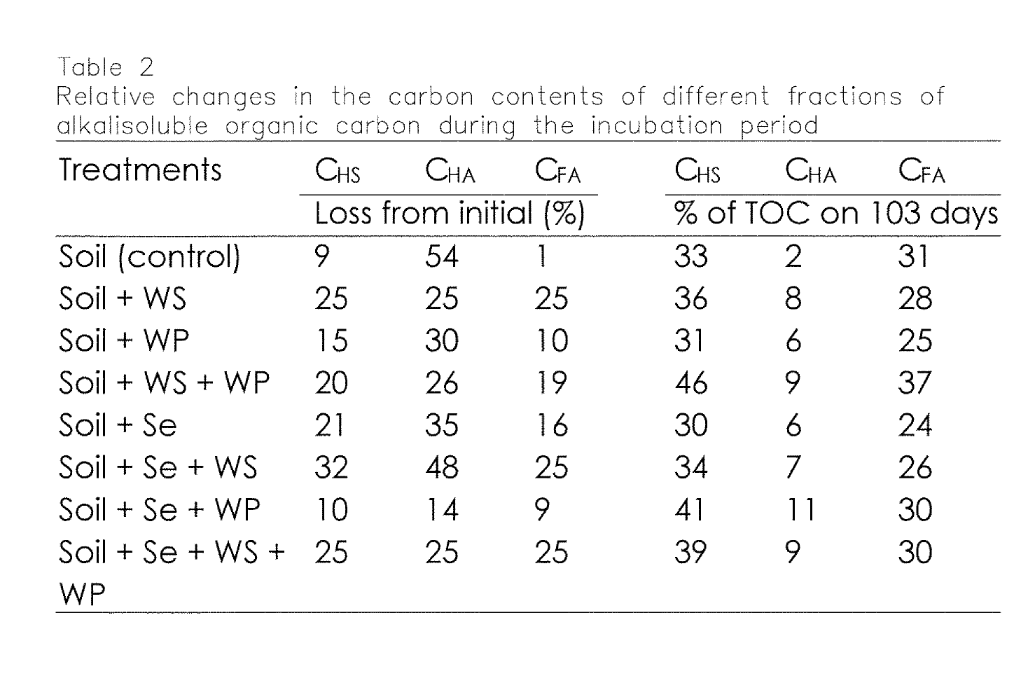

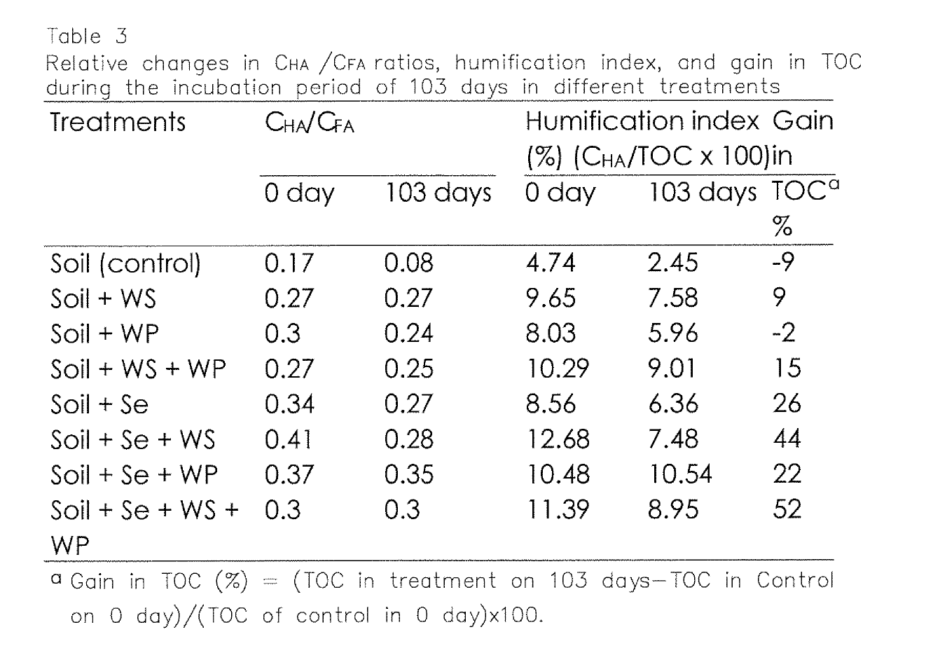

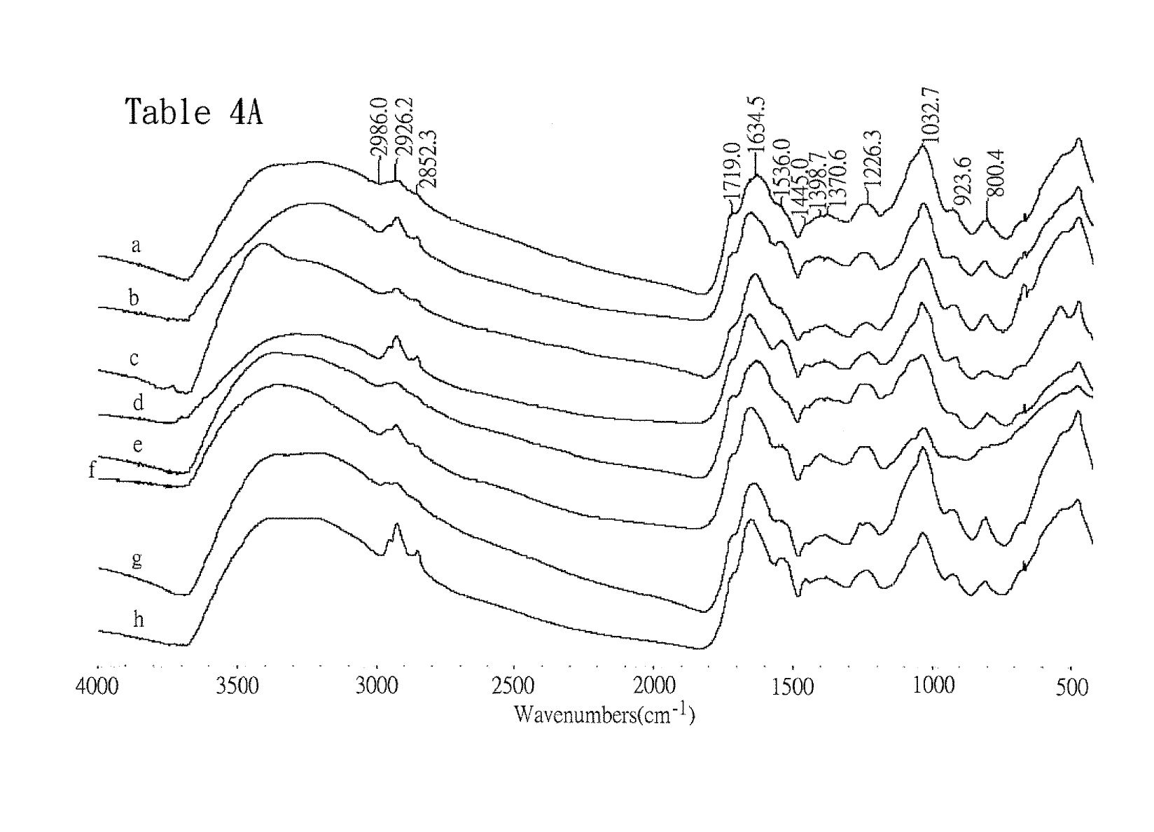

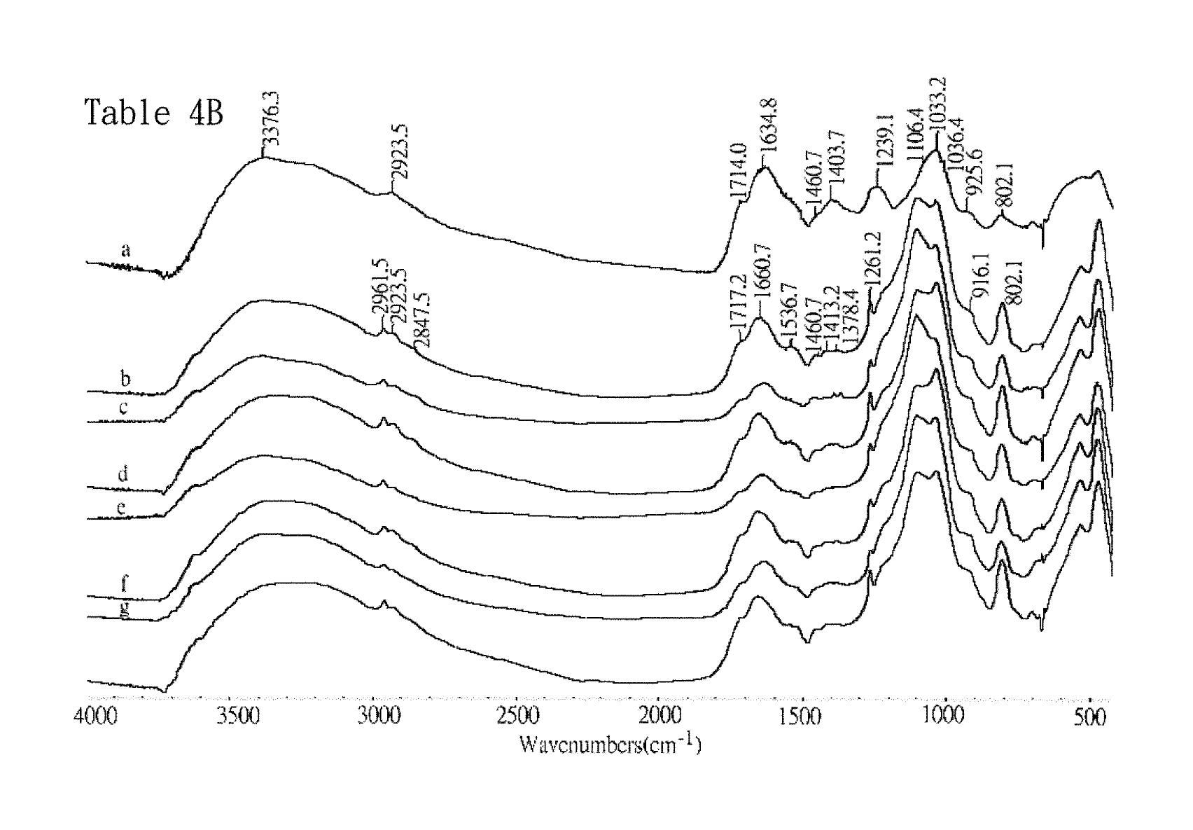

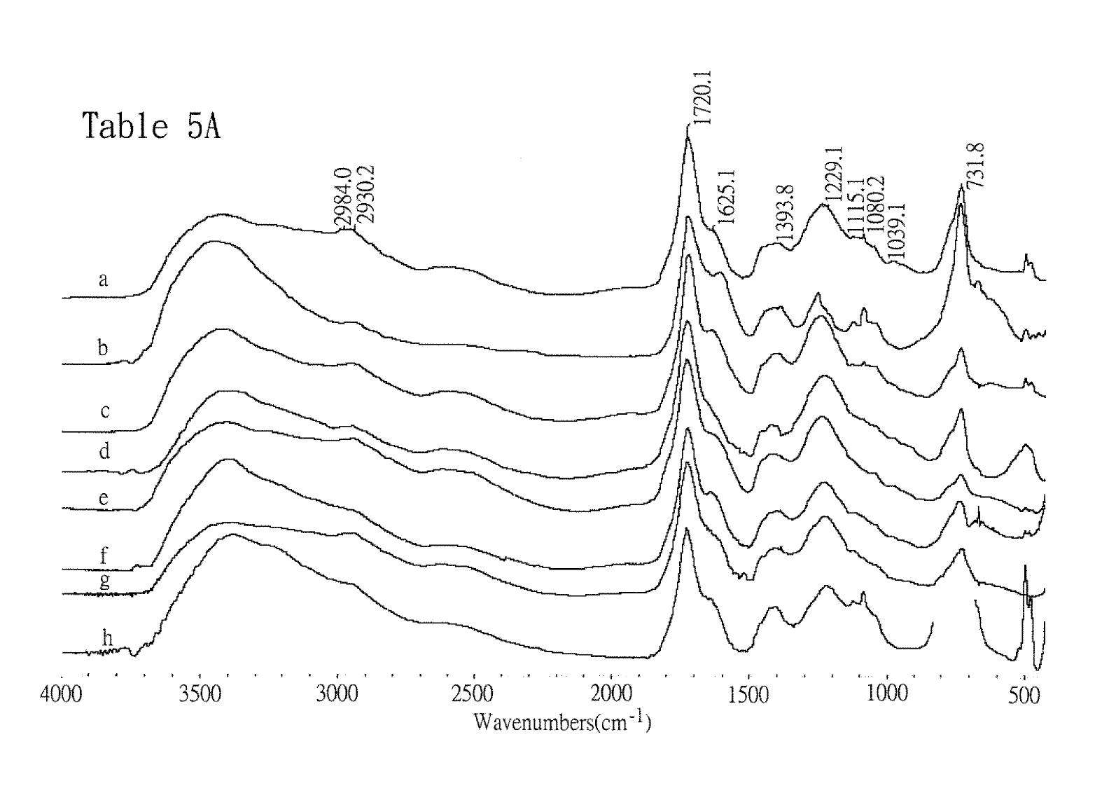

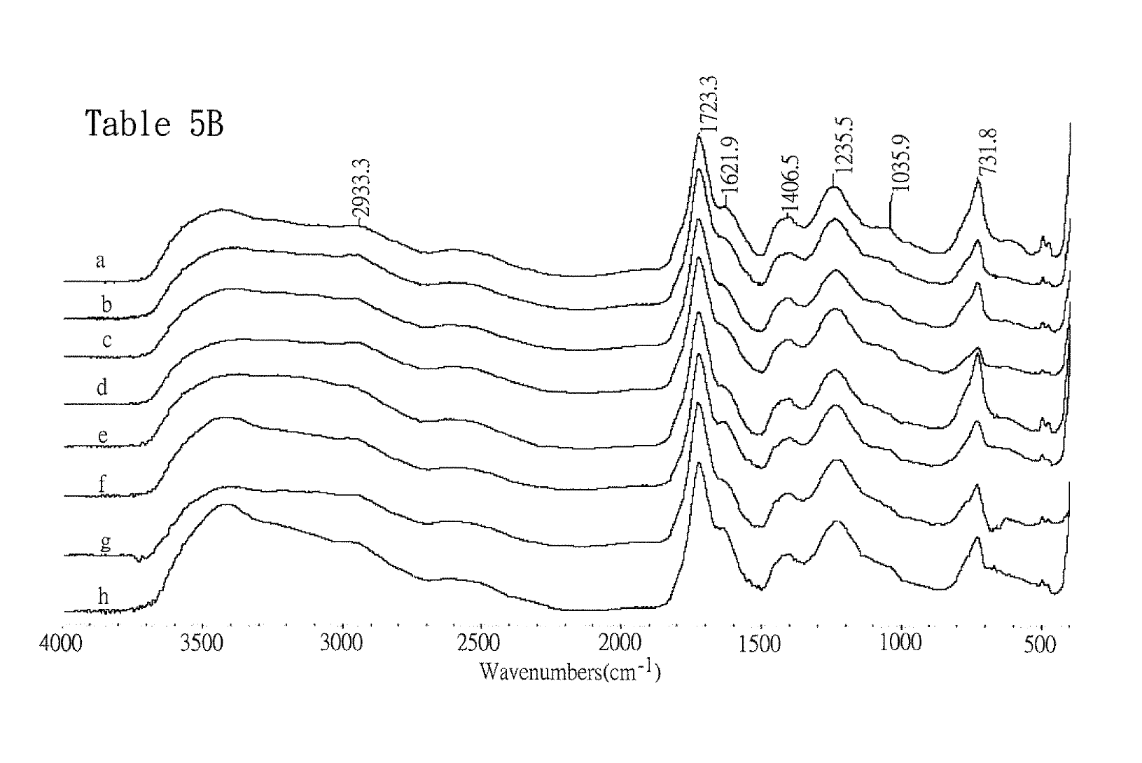

Furthermore, fulvic acid is soluble and mobile organic matter in soil. As illustrated in FIG. 3, the carbon contents of fulvic acid (C_{FA}) of all the treated soil during the incubation period trend down, and the carbon content of fulvic acid (C_{FA}) of the soil treated with addition of the food plant wastewater (WS) drops significantly. The carbon content of fulvic acid (C_{FA}) of the control soil (Soil) drops 1%, and the carbon content of fulvic acid (C_{FA}) of the soil with the addition of the paper mill wastewater (Soil+WP) drops 9%. After incubation of 33 days, the carbon content of fulvic acid (C_{FA}) of the soil with the application of sesbania (Soil+Se) and the carbon content of fulvic acid (C_{FA}) of the soil with the addition of the paper mill wastewater (Soil+WP) remain stable, and after incubation of 22 days, the carbon content of fulvic acid (C_{FA}) of the soil with the application of sesbania and with the addition of the food plant wastewater (Soil+Se+WS) and the carbon content of fulvic acid (C_{FA}) of the soil with the application of sesbania and with the addition of the paper mill wastewater (Soil+Se+WP) also remain stable. After incubation of 103 days, the carbon content of fulvic acid (C_{FA}) of the soil with the application of sesbania and with the addition of the food plant wastewater and the paper mill wastewater (Soil+Se+WS+WP) and the carbon content of fulvic acid (C_{FA}) of the soil with the addition of the food plant wastewater and the paper mill wastewater (Soil+WS+WP) are the highest.

In comparison with relative changes in the total organic carbon contents, the carbon contents of the humic substances (C_{HS}), the carbon contents of the humic acid (C_{HA}), and the carbon contents of fulvic acid (C_{FA}) of the soil during the incubation period among different treatments, as listed in Table 2, we can find that the carbon content of the humic acid (C_{HA}) of the control soil (Soil) drops the most after incubation of 103 days. It is shown that either the application of sesbania or the addition of the wastewater can increase the carbon content of the humic acid (C_{HA}) of the soil. The carbon content of the humic acid of the soil with the application of sesbania and with the addition of the paper mill wastewater (Soil+Se+WP) increases the most and contributes 11% of the total organic carbon, and the carbon content of the humic acid (C_{HA}) of the control soil (Soil) only contributes 2% of the total organic carbon. Therefore, the treatment with the application of sesbania or with the addition of the wastewater can effectively increase the ratio of the stable organic carbon (the carbon of the humic acid) in the soil.

In consideration of the ratio of the carbon content of the humic acid (C_{HA}) to the carbon content of the fulvic acid (C_{FA}), as listed in Table 3, it is also apparent that the treatments with the application of sesbania and with the addition of the wastewater can effectively increase the ratio of the carbon content of the humic acid (C_{HA}) to the carbon content of the fulvic acid (C_{FA}) of the soil.

### Test Example 3

### Relative Changes in the Spectral Characteristics of the Humic Acid and Fulvic Acid in the Soil Among Different Treatments During the Incubation Period

This study utilizes Fourier transform infrared spectrophotometry to analyze the changes in the structural characteristics of the humic acid and fulvic acid in the soil after incubation treatment. As listed in Table 4A, the Fourier transform infrared spectrum of the humic acid in all the treated soil before incubation (on the 0th day) has a strong peak (a hydrogen bond and an O—H group) from 3000 to 3400 cm⁻¹, a relatively gentle peak (an aromatic C—H bond) at 2954 cm⁻¹, small peaks (an asymmetric C—H bond and an aliphatic C—H bond) at 2930 cm⁻¹ and 2850 cm⁻¹ a relatively gentle peak (a C═O bond in a COOH group) at 1720 cm⁻¹, a peak (a C═C bond in an aromatic structure, a COO⁻ group and a hydrogen bond combined with a C═O bond) at 1635 cm⁻¹, a gentle peak (an amide bond) at 1535 cm⁻¹, a small peak (a C—H bond of a CH₂ or a CH₃ group) at 1450 cm⁻¹, a peak (a CH₂ and a COO⁻ groups) at 1405 cm⁻¹, a gentle peak (an aromatic C and a carboxylic C—O bond) at 1230 cm⁻¹, a gentle peak (a C—OH bond of an aliphatic O—H bond) at 1170 cm⁻¹, a peak (a polysaccharidic C—O bond) at 1035 cm⁻¹, and a sharp peak (a aliphatic C—H bond) at 800 cm⁻¹. It can be found from the humic acid extracted from the soil with the application of sesbania that its spectral characteristic has a higher peak at 1535 cm⁻¹. The reason is that humic acid contains N—H bonds similar to those in a polypeptide structure. The application of sesbania can provide a large amount of nitrogen to the soil. Additionally, the humic acid from the soil with the application of sesbania exhibits different absorption intensities at 2930 cm⁻¹ and 2850 cm⁻¹. It is shown that the application of sesbania will increase aliphatic hydrocarbons and polypeptide-like structures in the soil. From the humic acid extracted from the soil with the application of sesbania and with addition of the paper mill wastewater (Soil+Se+WP) and the soil with the application of sesbania and with the addition of the food plant wastewater and the paper mill wastewater (Soil+Se+WS+WP), we can find that their spectral characteristics have lower peak intensities at 1035 cm⁻¹. As listed in Table 4B, the primary changes in the spectral characteristic of the humic acid after incubation of 103 days include: (1) the peak intensities at 2930 cm⁻¹ and 2850 cm⁻¹ are lowered (the aliphatic region is reduced), (2) the peak intensity at 1635 cm⁻¹ is lowered (the aromatic region is reduced), and (3) the peak intensity at 1535 cm⁻¹ is lowered (the polyamide structures decrease). Moreover, the humic acid extracted from each of the treated soil contains more polypeptide structures than the humic acid from the control soil (peaks from 1000 to 1100 cm⁻¹).

As listed in Table 5A, the Fourier transform infrared spectrum of the fulvic acid in all the treated soil before incubation (on the 0th day) has a peak (a hydrogen bond and an O—H group) from 3000 to 3400 cm⁻¹, a small peak (an asymmetric C—H bond, a C—H bond of a hydrogen bond-COOH group) at 2930 cm⁻¹, a peak (an O—H group of an aliphatic CH) at 2600 cm⁻¹, a relatively gentle peak (a C═O bond in a COOH group) at 1720 cm⁻¹, a peak (a C═C bond in an aromatic structure, a COO⁻ group and a hydrogen bond combined with a C═O bond) at 1635 cm^{˜1}, a peak (a CH₂ and a COO⁻ groups) at 1410 cm⁻¹, a gentle peak (an aromatic C and a carboxylic C—O bond) at 1230 cm⁻¹, three small peaks at 1110 cm⁻¹, 1080 cm⁻¹ and 1035 cm⁻¹, and a sharp peak (a aliphatic C—H bond) at 730 cm⁻¹. Additionally, the fulvic acid contains aliphatic compounds and carbohydrates, and its spectral characteristic has peaks at 2930-2850 cm⁻¹ and 1050-1040 cm⁻¹. It can be found that fulvic acid contains less aliphatic compounds compared with the spectral characteristic of the humic acid. The peak at 1720 cm⁻¹ in the spectral characteristic of the fulvic acid is higher than the peak at 1630 cm⁻¹. It is shown that the aromatic groups in the fulvic acid are not the main structures. Subsequently, as listed in Table 5B, we can find that the spectral characteristics of the fulvic acid extracted from the control soil (Soil), the soil with the application of sesbania (Soil+Se), and the soil with the application of sesbania and with the addition of the food plant wastewater and the paper mill wastewater (Soil+Se+WS+WP) have no peaks at 1110 cm⁻¹, 1080 cm⁻¹ and 1035 cm⁻¹. The color ratio of the fulvic acid at 1720 cm⁻¹ (a carboxyl group) to that at 2930 cm⁻¹ (an aliphatic C—H bond) can be used to describe the saturation degree of the aliphatic compounds or carboxyl groups in the fulvic acid. The soil with the application of sesbania (Soil+Se) before incubation (on the 0th day) has a higher 1720 cm⁻¹/2930 cm⁻¹ color ratio, but after incubation of 103 days, the 1720 cm⁻¹/2930 cm⁻¹ color ratio is close to that of the fulvic acid in the control soil (Soil).

It is obvious from the result of this study that the application of sesbania and the addition of the wastewater can increase the content of the humic substances of the soil. In addition to stabilizing the organic matter in the soil, resourcelization and reuse of wastewater can be realized. Therefore, the technology of the present invention can facilitate the humification of the organic matter in the soil, thereby increasing and stabilizing the organic carbon content of the soil. Furthermore, it can cause increased carbon storage in agricultural ecosystems, and reduce the application of chemical fertilizers. Especially in the era of fertilizer prices remained highly elevated due to more and more expensive petroleum and energy, the carbon storage effects of high performance humification on agricultural soil can further improve the production benefit of a cultivated land.

I claim:

1. A method for increasing the organic carbon content of soil employing industrial wastewater and green manure crops, comprising adding industrial wastewater containing cyclic phenolic substances into the soil with the application of the green manure crops to increase the organic carbon content of the soil.

2. The method for increasing the organic carbon content of soil employing industrial wastewater and green manure crops as claimed in claim 1, wherein the green manure crop is a legume.

3. The method for increasing the organic carbon content of soil employing industrial wastewater and green manure crops as claimed in claim 2, wherein the green manure crop is one of sesbania (Sesbania roxburghii Merr.), sun hemp (Crotalaria juncea L.), soybeans (Glycine max L.), rape (Brassica campestris L.), Chinese milk vetch (Astragalus sinicus), Egyptian clover (Trifolium alexandrinum L.), vetch (Vicia spp.), radish, buch wheat (Fagopyrum esculentum), Pale-flowered knotweed (Polygonum lapathifolum L.), gumbearer, velvet bean (Mucuna capitata), yokohama bean (Stizolobium hassjoo), lupine (Lupinus micranthus Guss.) or peanut (Arachis hypogaea L.).

4. The method for increasing the organic carbon content of soil employing industrial wastewater and green manure crops as claimed in claim 1, wherein the application amount of the green manure crop is 0.1% to 10% based on the weight of the soil.

5. The method for increasing the organic carbon content of soil employing industrial wastewater and green manure crops as claimed in claim 1, wherein the ratio of the wastewater containing cyclic phenolic substances to the soil is 0.0016 to 1.

6. The method for increasing the organic carbon content of soil employing industrial wastewater and green manure crops as claimed in claim 1, wherein the industrial wastewater containing cyclic phenolic substances is collected from lignocellulose-containing wastewater discharged from a paper mill.

7. A method for increasing the organic carbon content of soil employing industrial wastewater and green manure crops, comprising adding industrial wastewater containing nitrogen compounds into the soil with the application of the green manure crops to increase the organic carbon content of the soil.

8. The method for increasing the organic carbon content of soil employing industrial wastewater and green manure crops as claimed in claim 7, wherein the green manure crop is a legume.

9. The method for increasing the organic carbon content of soil employing industrial wastewater and green manure crops as claimed in claim 8, wherein the green manure crop is one of sesbania (Sesbania roxburghii Merr.), sun hemp (Crotalaria juncea L.), soybeans (Glycine max L.), rape (Brassica compestris L.), Chinese milk vetch (Astragalus sinicus), Egyptian clover (Trifolium alexandrinum L.), vetch (Vicia spp.), radish, buch wheat (Fagopyrum esculentum), Pale-flowered knotweed (Polygonum lapathifolum L.), gumbearer, velvet bean (Mucuna capitata), yokohama bean (Stizolobium hassjoo), lupine (Lupines micranthus Guss.) or peanut (Arachis hypogaea L.).

10. The method for increasing the organic carbon content of soil employing industrial wastewater and green manure crops as claimed in claim 7, wherein the application amount of the green manure crop is 0.1% to 10% based on the weight of the soil.

11. The method for increasing the organic carbon content of soil employing industrial wastewater and green manure crops as claimed in claim 7, wherein the ratio of the wastewater containing nitrogen compounds to the soil is 0.0016 to 1.

12. The method for increasing the organic carbon content of soil employing industrial wastewater and green manure crops as claimed in claim 7, wherein the industrial wastewater containing nitrogen compounds is collected from amino acid-containing wastewater discharged from a food processing plant.

13. A method for increasing the organic carbon content of soil employing industrial wastewater and green manure crops, comprising adding industrial wastewater containing nitrogen compounds and cyclic phenolic substances into the soil with the application of the green manure crops to increase the organic carbon content of the soil.

14. The method for increasing the organic carbon content of soil employing industrial wastewater and green manure crops as claimed in claim 13, wherein the green manure crop is a legume.

15. The method for increasing the organic carbon content of soil employing industrial wastewater and green manure crops as claimed in claim 14, wherein the green manure crop is one of sesbania (Sesbania roxburghii Merr.) sun hemp (Crotalaria juncea L.), soybeans (Glycine max L.), rape (Brassica campestris L.), Chinese milk vetch (Astragalus sinicus), Egyptian clover (Trifolium alexandrinum L.), vetch (Vicia spp.), radish, buch wheat (Fagopyrum esculentum), Pale-flowered knotweed (Polygonum lapathifolum L.), gum bearer, velvet bean (Mucuna capitata), yokohama bean (Stizolobium hassjoo), lupine (Lupinus micranthus Guss.) or peanut (Arachis hypogaea L.).

16. The method for increasing the organic carbon content of soil employing industrial wastewater and green manure crops as claimed in claim 13, wherein the application amount of the green manure crop is 0.1% to 10% based on the weight of the soil.

17. The method for increasing the organic carbon content of soil employing industrial wastewater and green manure crops as claimed in claim 13, wherein the industrial wastewater containing nitrogen compounds and that containing cyclic phenolic substances are formulated and mixed at the ratio of 2:1.

18. The method for increasing the organic carbon content of soil employing industrial wastewater and green manure crops as claimed in claim 13, wherein the ratio of the wastewater containing nitrogen compounds and cyclic phenolic substances to the soil is 0.0016 to 1.

19. The method for increasing the organic carbon content of soil employing industrial wastewater and green manure crops as claimed in claim 13, wherein the industrial wastewater containing nitrogen compounds and that containing cyclic phenolic substances are collected from amino acid-containing wastewater discharged from a food processing plant and collected from lignocellulose-containing wastewater discharged from a paper mill respectively.
